(19) United States
(12) Patent Application Publication
(10) Pub. No.: US 2023/0108767 A1
(43) Pub. Date: Apr. 6, 2023

(54) STATIC CHEMICAL INHIBITOR SYSTEM FOR OFF-PLOT PIPING IMMUNITY

(71) Applicant: SAUDI ARABIAN OIL COMPANY, Dhahran (SA)

(72) Inventors: Ahmed T. Abdulmajeed, Abqaiq (SA); Nasser A. Alhajri, Abqaiq (SA); Hussain M. Khaiwani, Abqaiq (SA); Muhaned M. Feghia, Dharan (SA); Nasser M. Quzi, Abqaiq (SA)

(73) Assignee: SAUDI ARABIAN OIL COMPANY, Dhahran (SA)

(21) Appl. No.: 17/481,556

(22) Filed: Sep. 22, 2021

(51) Int. Cl. E21B 41/02; E21B 37/06; E21B 43/08

(52) U.S. Cl. CPC E21B 41/02; E21B 37/06; E21B 43/084; E21B 2200/04

(57) ABSTRACT

An inhibitor injection spool is provided. The spool includes a segment of pipeline configured to convey crude oil and to couple with a pipeline system conveying crude oil. The spool also includes a valve on a top side or an underside of the segment of pipeline such that an interior of the segment of pipeline is selectively accessible from an exterior of the segment of pipeline. A solid corrosion inhibitor is configured to traverse an interior of the valve and such that it is positioned within the interior of the segment of pipeline such that at least a portion of the solid corrosion inhibitor fluidly contacts the crude oil traversing the segment of pipeline. Two mesh screens are coupled to the interior of the segment of pipeline such that crude oil traversing the segment of pipeline may not bypass either the first or second mesh screens.

### BACKGROUND

Mild steel is an inexpensive and commonly used steel alloy that is weldable, hard and durable. However, mild steel generally exhibits poor corrosion resistance, especially when mild steel is exposed to aqueous acidic liquids. As such, mild steel requires protection from corrosion when it is exposed to acidic materials. In particular, oil and gas exploration and production operations commonly use mild steel equipment. These operations also commonly require the treatment of formations with well fluids containing acids to stimulate oil and gas production. These well fluids therefore contain corrosive media that attack the mild steel surfaces with which they come into contact.

In particular, corrosive well fluids may perforate or severely damage well equipment and thus reduce the efficiency of the corresponding operations. In addition, where the well fluids cause corrosion of well equipment having mild steel surfaces, the life of such equipment may be appreciably reduced.

### SUMMARY

This Summary is provided to introduce a selection of concepts that are further described in the Detailed Description. This Summary is not intended to identify key or essential features of the claimed subject matter, nor is it intended to be used as an aid in limiting the scope of the claimed subject matter.

In one aspect, embodiments disclosed relate to an inhibitor injection spool. The inhibitor injection spool may comprise a segment of pipeline configured to convey crude oil and to couple with a pipeline system conveying crude oil. The crude oil comprises a hydrocarbon fraction and a water fraction, or an emulsion thereof. The injection spool may also comprise a valve mounted to a top side of the segment of pipeline such that an interior of the segment of pipeline is selectively accessible from an exterior of the segment of pipeline. The injection spool may also comprise a solid corrosion inhibitor configured to traverse an interior of the valve such that it is positioned within the interior of the segment of pipeline and such that at least a portion of the solid corrosion inhibitor fluidly contacts the water fraction or the emulsion thereof traversing the segment of pipeline. The injection spool may also comprise a first mesh screen positioned upstream of the solid corrosion inhibitor and a second mesh screen positioned downstream of the solid corrosion inhibitor. Both the first and the second mesh screens may be coupled to the interior of the segment of pipeline such that crude oil traversing the segment of pipeline may not bypass either the first or second mesh screens.

In another aspect, embodiments disclosed relate to an inhibitor injection spool. The inhibitor injection spool may comprise a segment of pipeline configured to convey crude oil and to couple with a pipeline system conveying crude oil. The crude oil may comprise a hydrocarbon fraction and a water fraction, or an emulsion thereof. The inhibitor injection spool may further comprise a valve mounted to an underside of the segment of pipeline such that an interior of the segment of pipeline is selectively accessible from an exterior of the segment of pipeline. The inhibitor injection spool may comprise a corrosion inhibition rod that is coupled to an exterior portion of the valve such that the corrosion inhibitor rod traverses an interior of the valve, at least a portion thereof is positioned within the interior of the segment of pipeline, and at least a portion of the corrosion inhibition rod fluidly contacts the water fraction or the emulsion thereof traversing the segment of pipeline. In some embodiments, the corrosion inhibition rod may not fluidly contact the hydrocarbon fraction.

Other aspects and advantages of the claimed subject matter will be apparent from the following description and the appended Claims.

### BRIEF DESCRIPTION OF DRAWINGS

FIG. 1 is a schematic diagram of a production systems in accordance with one or more embodiments.

FIG. 2 is a schematic diagram of a corrosion inhibitor system in accordance with one or more embodiments.

FIG. 3 is a schematic diagram of a corrosion inhibitor system including a bypass line in accordance with one or more embodiments.

FIG. 4 is a schematic diagram of a corrosion inhibitor system in accordance with one or more embodiments.

### DETAILED DESCRIPTION

Fluid produced from hydrocarbon-bearing formations contains hydrocarbons, such as oil, natural gas, and condensates; saline water; and sand or grit from the reservoir and the wellbore. This production fluid is both a corrosive and erosive composition for standard pipes in the production line. Solid material, such as sand or grit, can physically degrade or erode pipeline materials, such as mild stainless steel. In addition to the erosion of pipelines due to regular contact with physically abrasive sand or grit, saline water and other chemical additives in the produced fluid can corrode pipeline materials. The chemical corrosion is exacerbated by the physical damage caused by small particles in the pipes. The result is rust or corrosion in the interior of wellhead and production lines. Accordingly, the protection of mild steel equipment against corrosion with effective inhibitors is desirable.

Corrosion inhibitors are used to reduce corrosion in pipelines. Many known corrosion inhibitors are in liquid form and require specialized equipment in order to introduce them into a pipeline. The use of such liquid corrosion inhibitors may be practical on established permanent wellheads, however, installation of chemical injection systems across scattered wells that are not equipped with such systems imposes numerous challenges. These challenges may include installation of new equipment and power supply lines, security of the equipment, and filling and monitoring the chemical injection systems.

The present disclosure relates to systems and methods for introducing solid corrosion inhibitors into a pipeline. The systems and methods disclosed here do not require specialized injection equipment and may be employed in any standard pipeline segment. As well, the systems do not require continuous monitoring; they are passive in nature by slow dissolution of the slightly soluble solid inhibitor. The systems and methods may overcome many of the challenges associated with the use of corrosion inhibitors in liquid form.

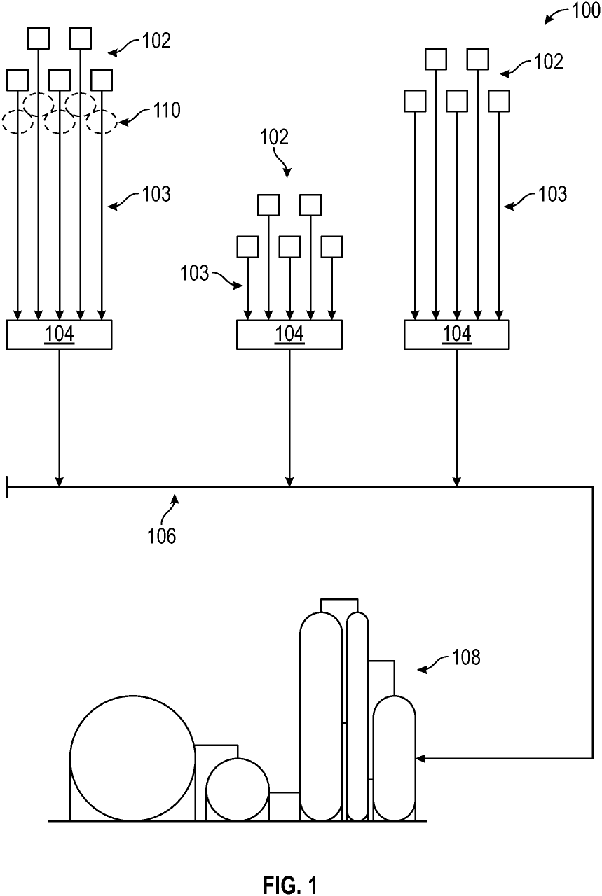

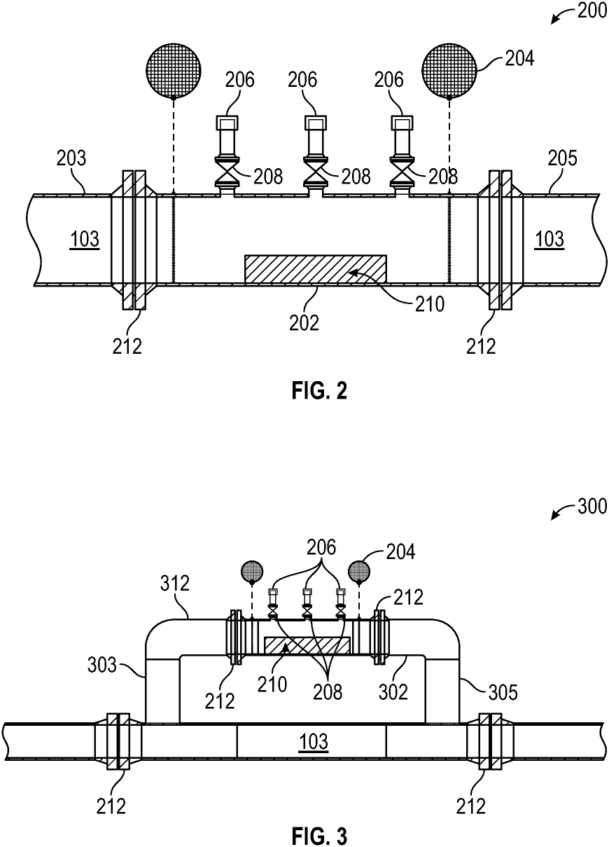

FIG. 1 illustrates a production system according to one or more embodiments. The production system 100 includes a plurality of wellheads 102, each producing a fluid from a reservoir that includes crude oil, saline water, and natural gas. The crude oil may contain a hydrocarbon fraction, a water fraction, or an emulsion thereof. The fluid produced from the reservoir may also include solid material, such as sand, grit, or mineral fragments, from the formation and wellbore. Each well 102 couples to a wellhead line 103 that directs the produced fluid from each wellhead 102 into a common fluid collection system, such as a gathering manifold 104. A corrosion inhibitor system 110 (also referred to as “inhibitor injection spool,” “corrosion inhibitor spool,” or “injection spool”) is located in the wellhead line 103 near the wellhead 102. The corrosion inhibitor system 110 will be explained in greater detail with regard to FIGS. 2 to 4. In the system shown in FIG. 1, only one corrosion inhibitor system 110 is depicted, however, a corrosion inhibitor system 110 may be included in any wellhead line 103. At the gathering manifold 104, the production flows (also referred to as “production fluid” or “fluid flows”) of several individual wells are combined together into a combined production flow (hereinafter also “combined fluid flow”). The combined production flow is directed through a production header coupled to the gathering manifold 104 and into a trunk line 106. The trunk line 106 runs along several modified gathering manifolds 104, collecting and aggregating together several production flows. The trunk line 106 provides the combined production flow to a processing facility 108 for initial field handling, such as the separation of the saline water and natural gas from the unrefined crude oil in preparation for long-distance pipeline or truck transport of these well fluid components.

For wells in which a corrosion inhibitor system 110 is used, the corrosion inhibitor system 110 in accordance with one or more embodiments is located near the wellhead 102. In particular embodiments, it may be located at the first spool downstream from the wellhead. As will be explained in greater detail, the corrosion inhibitor system is designed such that it can be readily implemented in an existing pipeline system.

FIG. 2 depicts a corrosion inhibitor spool in accordance with one or more embodiments. The injection spool 200 includes a segment of wellhead pipeline 202 along the previously described wellhead line 103. Production fluid flows through from an upstream end 205 to a downstream end 203 of the pipeline segment. In one or more embodiments, the pipeline segment 202 may be in a range of from about 10 to 14 meters in length. Shown in the interior of the segment of wellhead piping 202 are two mesh screens 204: one located upstream and one located downstream from the solid corrosion inhibitor 210. The mesh screens are positioned such that the mesh wire portion of the screen is in the interior, fluid-contacting portion of the pipeline segment 202. The production fluid must pass through the mesh screens 204 and may not bypass either. The shape and size of the mesh screens 204 are generally configured such that the wire screen portion corresponds to the shape and size of the interior of the piping segment 202. The mesh size should be large enough to permit fluid flow and not hinder fluid flow through the piping segment. However, the mesh size should be small enough to prevent solid corrosion inhibitor from being carried downstream.

A top portion of the injection spool 200 includes three filling ports 206. Any number of filling ports may be included on the injection spool. The filling ports may be any suitable shape, and in particular embodiments, may be in the form of a cylinder of about two to four inches in diameter. In order to introduce a solid corrosion inhibitor 210 into the pipeline segment 202, the solid corrosion inhibitor 210 may first be introduced into a filling port 206. Each filling port 206 includes a valve through which the solid corrosion inhibitor may be introduced into the filling port 206 (not shown). In the embodiment shown in FIG. 2, the solid corrosion inhibitor 210 is depicted at the bottom of the pipeline segment after being introduced through a filling port 206.

Each filling port 206 is coupled to a valve 208. The valve provides selective fluid communication between the filling port and the interior of the pipeline segment 202. Any valve that may be opened and closed to selectively introduce solid corrosion inhibitor and fluidly isolate the filling port from the pipeline segment may be used. In one or more embodiments, the valve may be a ¼-turn ball valve.

The solid corrosion inhibitor 210 may be any solid corrosion inhibitor known in the art. The solid corrosion inhibitor is a solid at room temperature and is at least slightly soluble in water such that it may dissolve over a period in the pipeline while exposed to the aqueous phase of the produced crude oil. The solid corrosion inhibitor 210 may take any solid form, including granular, pelletized, stick, spool, rod, and combinations thereof, so long as the solid corrosion inhibitor is a size and shape suitable for introduction via the filling port 206 and valve 208. The size and shape of the solid corrosion inhibitor may be appropriately selected based on the chemistry of the solid corrosion inhibitor and the inhibition rate.

The segment of wellhead pipeline 202 that defines the injection spool 200 includes two flanges 212: one at the upstream end 205 and one at the downstream end 203 of the segment. The flanges 212 are configured to fit standard pipeline fittings such that the injection spool 200 may be exchanged for a normal segment of pipeline near the wellhead. As such, the injection spool may be prefabricated at another location and added to pipelines as needed for corrosion resistance. As well, the spool may be removed if it is determined that passive introduction of corrosion inhibitor is no longer desired for the downstream pipeline.

As may be appreciated by those skilled in the art, more than one injection spool 200 may be included in a pipeline. Additional injection spools may be used to boost the corrosion inhibition in the pipeline as needed. For example, in one or more embodiments, an additional injection spool 200 may be included before the gathering manifold 104, after the gathering manifold 104, or both before and after the gathering manifold 104. Additionally, injection spools may be included in a portion of the trunk line 106 in one or more embodiments.

Another corrosion inhibition system 300 in accordance with one or more embodiments is shown in FIG. 3. In the embodiment shown in FIG. 3, the corrosion inhibitor spool is located in a bypass line 312 that makes up a segment 302 of pipeline bypassing a segment of the wellhead line 103. The mesh screens 204, filling ports 206, valves 208, and solid corrosion inhibitor 210 are as previously described. Fluid from the well flows from an upstream end 305 to a downstream end 303 through the interior of the bypass line 312.

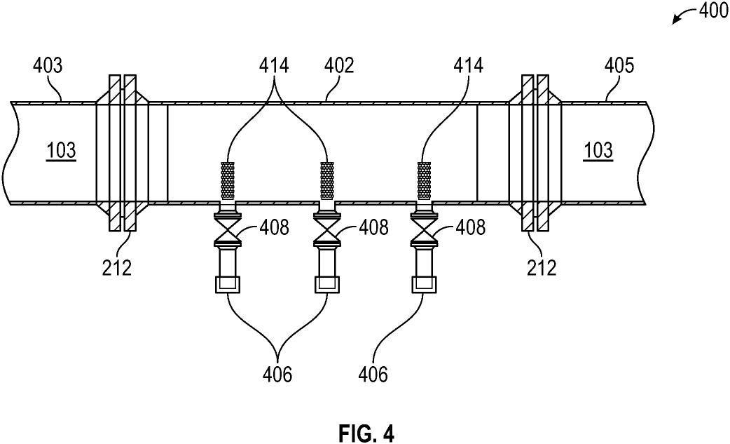

FIG. 4 depicts a configuration of a corrosion inhibition system 400 in accordance with one or more embodiments. FIG. 4 shows an alternative configuration for introducing solid corrosion inhibitor to the pipeline segment 402. The pipeline segment has an upstream end 405 and a downstream end 403. The underside of injection spool includes three filling ports 406. Each filling port 406 is connected to a valve 408 that provides selective fluid communication with the interior of the pipeline segment 402. The valve 408 is used to introduce the solid corrosion inhibitor 414 into the pipeline segment 402. In one or more embodiments, the valve 408 may be an isolation valve. The solid corrosion inhibitor 414 is in the form of a rod or a stick.

In embodiments in which the filling ports 406 are on the underside of the pipeline segment 402, in order to introduce the solid corrosion inhibitor 414 into the pipeline segment 402, the pipeline may be depressurized and then the pipeline segment 402 may be rotated in order to access the filling ports 406. The pipeline may be rotated using equipment such as a crane or a boom truck, for example. After rotating the pipeline segment 402, the solid corrosion inhibitor 414 may be introduced into the filling ports 406. In one or more embodiments, the solid corrosion inhibitor 414 may be secured in a holder to keep it in place. Once the solid corrosion inhibitor 414 has been introduced, the pipeline segment 402 may be rotated back to the original position with the filling ports on the underside of the pipeline segment 402.

A configuration in which the solid corrosion inhibitor is secured in the bottom of the pipeline, as shown in FIG. 4, may be particularly useful for in pipelines having a small water cut. In these configurations, the solid corrosion inhibitor is in more direct contact with the water phase while having minimal contact with the hydrocarbon phase.

The segment of wellhead piping 402 includes flanges 212 as previously described with regard to the spool shown in FIG. 2. Mesh screens are also provided as shown in FIG. 2. In one or more embodiments, the configuration shown in FIG. 4 may be located on a bypass line as shown in FIG. 3.

One or more embodiments of the present disclosure relate to a method of using a corrosion inhibitor spool to reduce corrosion in a pipeline, such as the spool illustrated in FIG. 2. The method includes introducing a solid corrosion inhibitor into the pipeline segment. When the well is shut-in, the pipeline is depressurized, allowing for the introduction of the solid corrosion inhibitor. The solid corrosion inhibitor 210 is introduced into a pipeline segment by first introducing the solid corrosion inhibitor 210 into the filling port 206 and then introducing the solid corrosion inhibitor into the interior of the pipeline segment 202 via the valve 208. The cap on the filling port 206 is removed and the solid corrosion inhibitor 210 is inserted into the filling port 206. Once the solid corrosion inhibitor 210 has been placed inside the filling port, the cap of the filling port 206 is put back in position.

The solid corrosion inhibitor may then be introduced into the interior of the pipeline segment 202 via the valve 208. The valve 208 is opened such that the solid corrosion inhibitor 210 traverses the interior of the valve 208, passing into the pipeline segment 202. As illustrated in FIG. 2, due to gravitational force, the solid corrosion inhibitor will fall from its location inside the valve to the bottom of the interior of the pipeline. Once the solid corrosion inhibitor 210 is inside the pipeline segment 202, the valve 208 is closed, and the pipeline may be pressurized and used for the transport of production fluid. As the produced fluid is passed through the pipeline, the solid corrosion inhibitor 210 fluidly contacts at least a portion of the production fluid and in particular, contacts at least a portion of the water fraction of the production fluid or the emulsion, which will contain at least a portion of the water phase. The solid corrosion inhibitor slowly dissolves into the water phase and reacts with either the corrosive species in the water phase or inhibits the metal walls of the production piping providing a barrier between the metal pipeline material and the corrosive species.

As the production fluid flows from the upstream portion of the pipeline segment 205 to the downstream portion of the pipeline segment 203, some of the solid corrosion inhibitor may move downstream. However, due to the presence of the mesh screens 204 in some instances the solid corrosion inhibitor remains in the pipeline segment 202 of the injection spool 200 until it is sufficiently small such that it can traverse through the openings of the mesh screen. The mesh screens ensure that the solid corrosion inhibitor contacts the fluid in the pipeline as early as possible in the flow so that the rest of the pipeline is protected from corrosion.

A similar method of reducing corrosion in production pipelines may be conducted using a system as shown in FIG. 4. The method may also take place when the well is shut-in and the pipeline depressurized. The solid corrosion inhibitor 414 in the form of a stick or a rod is introduced from the bottom side of the pipeline.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

Thus, particular implementations of the subject matter have been described. Other implementations are within the scope of the following claims

Although only a few example embodiments have been described in detail, those skilled in the art will readily appreciate that many modifications are possible in the example embodiments without materially departing from the scope of the disclosure. Accordingly, all such modifications are intended to be included within the scope of this disclosure as defined in the following claims. In the claims, means-plus-function clauses are intended to cover the structures described as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims, except for those in which the claim expressly uses the words ‘means for’ together with an associated function.

It is noted that one or more of the following claims utilize the term “where” or “in which” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.” For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter. The transitional phrases “consisting of” and “consisting essentially of” may be interpreted to be subsets of the open-ended transitional phrases, such as “comprising” and “including,” such that any use of an open-ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B, and C should be interpreted as also disclosing a composition “consisting of” components A, B, and C as well as a composition “consisting essentially of” components A, B, and C. Any quantitative value expressed in the present application may be considered to include open-ended embodiments consistent with the transitional phrases “comprising” or “including” as well as closed or partially closed embodiments consistent with the transitional phrases “consisting of” and “consisting essentially of.” The words “comprise,” “has,” and “include” and all grammatical variations thereof are each intended to have an open, non-limiting meaning that does not exclude additional elements or steps.

What is claimed:

1. An inhibitor injection spool comprising:
a segment of pipeline configured to convey crude oil and to couple with a pipeline system conveying crude oil, where the crude oil comprises a hydrocarbon fraction and a water fraction, or an emulsion thereof;
a valve on a top side of the segment of pipeline such that an interior of the segment of pipeline is selectively accessible from an exterior of the segment of pipeline;
a solid corrosion inhibitor configured to traverse an interior of the valve and such that it is positioned within the interior of the segment of pipeline such that at least a portion of the solid corrosion inhibitor fluidly contacts the water fraction or the emulsion thereof traversing the segment of pipeline; and
a first mesh screen positioned upstream of the solid corrosion inhibitor and a second mesh screen positioned downstream of the solid corrosion inhibitor, both the first and the second mesh screens coupled to the interior of the segment of pipeline such that crude oil traversing the segment of pipeline may not bypass either the first or second mesh screens.

2. The inhibitor injection spool of claim 1, further comprising a filling port coupled to the valve.

3. The inhibitor injection spool of claim 1, where the valve is a ball valve.

4. The inhibitor injection spool of claim 1, where the solid corrosion inhibitor is in a form selected from the group consisting of granular, pelletized, stick, spool, rod, and combinations thereof.

5. The inhibitor injection spool of claim 1, where the injection spool is located on a bypass line.

6. A production system comprising an inhibitor injection spool of claim 1.

7. A method of using a production system comprising:
introducing a crude oil into an inhibitor injection spool of claim 1 such that the crude oil traversing the segment of pipeline fluidly contacts at least a portion of solid corrosion inhibitor within the interior of the segment of pipeline.

8. An inhibitor injection spool comprising:
a segment of pipeline configured to convey crude oil and to couple with a pipeline system conveying crude oil, where the crude oil comprises a hydrocarbon fraction and a water fraction, or an emulsion thereof;
a valve mounted to an underside of the segment of pipeline such that an interior of the segment of pipeline is selectively accessible from an exterior of the segment of pipeline; and
a corrosion inhibition rod coupled to an exterior portion of the valve such that the corrosion inhibitor rod traverses an interior of the valve and at least a portion thereof is positioned within the interior of the segment of pipeline such that the at least a portion of the corrosion inhibition rod fluidly contacts the water fraction or the emulsion thereof traversing the segment of pipeline and not the hydrocarbon fraction.

9. The inhibitor injection spool of claim 8, further comprising a filling port coupled to the valve.

10. The inhibitor injection spool of claim 8, where the valve is an isolation valve.

11. The inhibitor injection spool of claim 8, further comprising a first mesh screen positioned upstream of the corrosion inhibition rod and a second mesh screen positioned downstream of the corrosion inhibition rod, both the first and the second mesh screens coupled to the interior of the segment of pipeline such that crude oil traversing the segment of pipeline may not bypass either the first or second mesh screens.

12. The inhibitor injection spool of claim 8, further comprising a holder configured to hold the solid corrosion inhibitor in place.

13. The inhibitor injection spool of claim 8, where the injection spool is located on a bypass line.

14. A production system comprising an inhibitor injection spool of claim 8.

15. A method of reducing corrosion in wellhead piping, the method comprising:
introducing a crude oil into an inhibitor injection spool, wherein the inhibitor injection spool comprises:
a segment of pipeline configured to convey crude oil and to couple with a pipeline system conveying crude oil, where the crude oil comprises a hydrocarbon fraction and a water fraction, or an emulsion thereof;
a valve mounted to an underside of the segment of pipeline such that an interior of the segment of pipeline is selectively accessible from an exterior of the segment of pipeline;
a corrosion inhibition rod coupled to an exterior portion of the valve such that the corrosion inhibitor rod traverses an interior of the valve and at least a portion thereof is positioned within the interior of the segment of pipeline such that the at least a portion of the corrosion inhibition rod fluidly contacts the water fraction or the emulsion thereof traversing the segment of pipeline and not the hydrocarbon fraction; and
contacting the crude oil with at least a portion of the solid corrosion inhibitor within an interior of the inhibitor injection spool.

16. The method of claim 15, further comprising, prior to introducing crude oil into an inhibitor injection spool, introducing the corrosion inhibition rod into the segment of pipeline via the valve.

17. The method of claim 16 further comprising, prior to introducing the corrosion inhibition rod into the segment of pipeline via the valve, depressurizing the segment of pipeline.

18. The method of claim 17, further comprising, after depressurizing the segment of pipeline, rotating the segment of pipeline such that the valve is on a topside of the segment.

19. The method of claim 18, further comprising, after introducing the corrosion inhibition rod into the segment of pipeline via the valve and prior to introducing a crude oil into an inhibitor injection spool , rotating the pipeline segment back to a position such that the valve is on the underside of the pipeline segment.
